(19) United States
(12) Patent Application Publication
(10) Pub. No.: US 2009/0226860 A1
(43) Pub. Date: Sep. 10, 2009

(54) Talk-n-Drum Foreign Language and music program

(76) Inventors: Nanette Garcia, (US); Maurice Minichino, Yorktown Hts, NY (US)

Correspondence Address: Talk-N-Drum Corp., 2481 Evergreen St., Yorktown HTS, NY, 10598, US

(21) Appl. No.: 12/042,334

(22) Filed: Mar. 5, 2008

(51) Int. Cl. G09B 19/06

(52) U.S. Cl. 434/157

(57) ABSTRACT

A method of teaching language utilizing percussion instruments, an original repertoire of songs and specific body movements. Students unconsciously learn the structure and sound of words and complete phrases of the language by playing percussion instruments, speaking, chanting and singing specially composed songs combined with specific physical movements (auditive, kinesthetic and visual senses). The combined activities follow the natural pulse and dynamics of the language. Nonverbal communication (para linguistic) is used and follows the rhythm of the exercises. The students do basic music ear training exercises using percussion instruments to focus on the rhythm of sound and to develop listening and concentration skills. The method includes breathing exercises for relaxation combined with the vowel positions and sounds of the language, and vocal sound exercises to teach physical adaptation for pronunciation. Through repetition students retain the language by recalling a rhythmic pattern, a chant or melodic quality of a song, or a body movement. Focus is on the overall exercise and no linguistic corrections are made to keep the language learning process stress free and creative.

### BACKGROUND OF THE INVENTION

1. Field of the Invention

The present invention relates to a language teaching method and more particularly to a method for teaching a native or foreign language including teaching structure and sound awareness through rhythm to students learning a new language or a basic language with varying levels of intelligence, and to students with learning disabilities, speech and/or hearing impairments, and to students sixty (60) years of age and over to stimulate brain function.

2. Description of Prior Art

There has been much research done in the area of language acquisition in the past fifty (50) years from which many multi sensory or sensory fusion teaching methods have sprung.

In 1969 James Asher introduced TPR (Total Physical Response), a method based on a model of how children learn their first language. Asher talks about three (3) critical stages of language learning.

First stage is listening and comprehension before speaking. Second stage is connecting spoken and body language or language-body conversation. This begins when parent speaks and infant answers with a physical response. At this stage the child is internalizing the patterns and sounds of the language. Third stage is readiness for the child to speak. Students learning with the TPR method receive language chunks over a listening or silent period without translation. Students learn by connecting physical movements and visual aides with language. When students begin speaking they are spontaneous and errors are not corrected.

In 1977, Linguist and educational researcher Stephen Krashen, along with co-founder Tracy Terrell, established the natural approach to second language learning known as the ‘Monitor Theory’. This method is based on ‘acquired’ and ‘learned’ language information. Acquired knowledge or natural language acquisition is unconscious and happens when exposed to ‘comprehensible input’ which is input at a slightly higher level than the learner's performance. This acquisition occurs in communicative situations, a learning environment that is free of anxiety. Monitored ‘learning’ is conscious and occurs in a classroom where a teacher expands the knowledge of the language such as grammatical structures accepting all attempts at communicating in the target language.

In the 1970s Bulgarian educator and psychologist Georgi Lozanov lead the way in the field of accelerated learning and developed the suggestopedia method. Suggestopedia is a system for liberating the mind of stress to allow spontaneous acquisition of knowledge, skills and habits on the conscious and subconscious levels. Classical music is played as material is presented by the teacher in a calm manner. Students will occasionally read along with the teacher. The Students then play games or sing songs then verbally interact in the target language with few corrections made.

Brain Gym is a method that came out of a kinesiological study done by Dr. Paul Dennison in 1969. Brain Gym is a program based on the idea that specific body movements stimulate brain function. Dennison put together a system of enjoyable activities that prepare the brain and nervous system for high level learning in all areas. The method is designed to help concentration, memory, language and number skills, reading, writing, speaking and athletic performance.

In the 1980's, methods based on learning language through authentic and meaningful communications were developed. Acquiring fluency is done through interactive approaches treating the process as a creative one that requires trial and error.

### SUMMARY OF THE INVENTION

The present invention is a multi sensory language teaching method based on the principal that each language has a natural rhythmic pulse. By combining playing a percussion instrument, performing specific rhythmic movements, speaking, singing specially composed songs or chanting in the target language students unconsciously learn the rhythm and sound of the new words and phrases.

Relaxation and physical adaptation exercises cover one embodiment of the present invention. To relax and prepare the body for kinesthetic learning, students isolate and shake different parts of the body and name the parts in the native language then in the target language.

In physical adaptation exercises students do verbal imitations of specific animal sounds to prepare the mouth and tongue for the new pronunciation. Deep breathing exercises to relax the body are combined with the vowel positions and sounds of the language. Through repetition the tongue and mouth work together with more fluidity to pronounce the new words and phrases with the correct accent.

Playing percussion instruments, ear training, speaking, chanting singing specially composed prerecorded songs in the target language, and specific rhythmic body movements cover another embodiment of the present invention. Students drum rhythmic patterns on the instrument that follow the rhythm of the language as they speak, chant or sing songs because the mind is pattern seeking (auditive, kinesthetic and visual).

To develop listening, focusing and concentration skills, and to prepare the ear to hear the rhythmic and melodic qualities of the new language, ear training exercises are done. The teacher plays a rhythm that consists of no more than four (4) notes of varying durations and dynamics on a percussion instrument and students repeat the rhythm on their instrument. Teacher repeats the exercise with students closing their eyes. The patterns are played in a repetitive fashion for better memory retention and to develop focus and listening skills.

Specific physical movements are performed and follow the rhythm of the language as students speak, sing songs or chant because the mind is pattern seeking (auditive, kinesthetic and visual). Movements are combined and follow rhythmic patterns drummed on an instrument or are combined with speaking, singing or chanting without drumming, and are performed in a repetitive fashion for muscle memory retention (kinesthetic).

For students under five (5) years of age with varying levels of intelligence, and for students with disabilities, manipulation of small hand held percussion instruments develop fine motor skills. Drumming on bongos or a single headed drum with both or one hand develops gross motor skills and hand-eye coordination. Combining instrument playing and body movements develops gross motor skills and coordination. For students sixty (60) years of age and over combining instrument playing and body movements improves and maintains coordination and physical balance.

Drum playing and body movements are combined with and follow the rhythm of prerecorded songs and chants in the target language so students hear, feel and see the new language. All songs have memorable melodic and rhythmic qualities designed to teach the structure and sound of new linguistic items by emphasizing the main pulse, dynamics, pauses and hesitations. Songs are lively in spirit and are no longer than two and a half (2½) minutes in length. Each chant contains no more than three (3) words, no more than three (3) minutes in length and have memorable rhythmic qualities designed to break up words into syllables with their emphasis. Chants are lead by the teacher in a lively and enjoyable way. Songs and chants are grouped thematically and are included in set curriculums. Non verbal communication (para linguistics) such as gestures, vocal inflections, emotions and dynamics are used and follow the rhythmic beat.

The present invention is based on the concept that language acquisition is natural and pleasurable when put in a musical context with the emphasis on rhythm. With basic music ear training and practicing new words and phrases in a rhythmic and melodic context in a repetitive fashion, the students unconsciously learn the structure and sound of the new language. No linguistic structures or rules are explained nor are pronunciation corrections made in order to keep the learning stress free and enjoyable. Students perceive the language as an art form and the learning process as a creative one where verbal experimentation is key and all outcomes, including those considered outside of the boundaries of correctness, useful to the overall process.

In this method students hear, feel and see the ‘pulse’ of the language, syllables and emphasis, dynamics, pauses and hesitations through rhythm and melody. The reiterative nature of rhythm lends to repetitive practice of the new words and phrases which is important for long term memory.

This invention recognizes that language is learned through authentic and meaningful communication. Speaking, singing specially composed songs or chanting in the target language combined with playing percussion instruments and specific body movements in a collective class provides students with a sense of community giving language learning a deeper meaning and purpose.

New linguistic items are put into thematic form or curriculums for students to build a mental filing system of words and phrases that have connections. The invention combines the rhythmic and melodic patterns of the language to create brain and muscle memory or unconscious learning, with authentic communication or conscious understanding.

The present invention is a method of teaching a foreign and a native language to students of varying levels of intelligence, and a basic language structure to students with learning disabilities, autism, dyslexia, attention deficit disorder, and speech and/or hearing impairments. Students with special needs access the sound and structure of the new language kinesthetically and visually as well as auditively by unconsciously connecting the spoken, sung or chanted words and phrases to beats played either on an instrument or to rhythmic body movements.

For seniors, population sixty years of age and over, the mind and body work together to access the sound and structure of the new language with drumming and body movements stimulating muscle function and speaking, singing and chanting in the new language stimulating neuron activity to promote cognition, recall, and enhance memory skills.

In summary, the present invention is a method of teaching language through rhythm, songs and chants belonging to an original repertoire, specific body movements, breathing exercises, physical adaptation exercises and non verbal communication (para linguistics)

### DETAILED DESCRIPTION OF THE INVENTION

The method of the present invention consists of eight (8) sections (in a single session) for teaching foreign language to students of varying intellectual levels and to seniors over sixty (60) years of age to stimulate brain function, and for teaching a basic language structure to students with learning disabilities and hearing and /or speech impairments. The lessons are presented in thematic form with all linguistic items relating to the theme.

1—Relaxation and Physical Adaptation:
A—Students isolate and shake parts of the body and say the name of the part in the native and then in target language.
B—Students move the tongue inside the mouth to become aware of the muscle. The teacher says the word for tongue in the target language and students repeat the word.
C—Students vocally imitate certain animal sounds for tongue position and movement for the new pronunciation.
D—Students do deep inhales and exhales combined with vowel positions and sounds of the target language.
E—Students chant and clap the rhythm of an introduction phrase in the target language as a group. After each time this phrase is chanted one student says his/her name.

2—Ear Training: ‘Call and Answer’ Exercise.

Teacher introduces the first percussion instrument and plays a group of notes of varied durations and dynamics at a slow to moderate tempo. Students listen and drum the same combination of notes on their instruments. ‘Sticking’ (the order in which the sticks, mallets or hands hit the instrument) is also repeated by the student on the instrument. Repeating the sticking develops gross motor skills and hand-eye coordination. After a few rounds of call and answer drumming students continue the exercise with eyes closed for another few rounds to focus on listening.

3—Continuing with eyes closed or opened, the call and answer exercise is done with numbers in the target language. The teacher says one (1) to three (3) numbers in sequence in the target language and drums the rhythm of the words at a slow to moderate tempo. Students repeat the words and beats on their instrument.

The teacher then drums specific dynamics and calls out the word for each dynamic in the target language. Students listen then drum the dynamic and repeat the word for the dynamic.

The teacher repeats the exercise at varied tempos. Students repeat the word for the tempo as they drum it on the instrument. Students cognitively link the word with the corresponding movement and action.

After a few rounds of the exercise, the teacher drums the dynamic or tempo and says the word for each once again and elicits the meaning of each word from the students to make them aware of the connection between the action and linguistic items.

4—Students sing along with a prerecorded ‘Greeting’ song in the target language. At the first session with a group the teacher breaks down each word of the complete phrases of the song by saying and beating the rhythm of each on a percussion instrument at a slow to moderate tempo. Students repeat the words and beats on the instrument. Students then sing along with the prerecorded greeting song and drum a simple down beat rhythm.

5—The teacher presents the theme of the session by introducing related words (cognates when possible) and short phrases contained in the prerecorded song/s or chant that will follow. To give meaning to the new linguistic items the teacher engages students in a simple conversation about the theme using the new items in the native language then translating them into the target language. The teacher then breaks down single words or complete phrases by saying and drumming them on the instrument at a slow to moderate tempo. The students listen and repeat along with the teacher.

6—Teacher introduces a second percussion instrument and repeats the break down of the linguistic items by saying each word of the complete phrase with drummed beats and a simple rhythmic body movement that follows the beats. Students repeat the words of the phrase with drummed beats and body movement. The students then repeat the phrase, drummed beats and body movement with a prerecorded song or a chant. Para linguistics are included in the exercise and follow the main rhythm. By adding gestures, vocal tones, inflections and emotions, students make further cognitive connections and help long term memory.

7—The teacher elicits the new linguistic items from the students to make them consciously aware of what they have learned and to achieve long term memory. It is also a way for the teacher to assess how much the students have internalized. No linguistic corrections are made as all attempts to speak the language are important to the overall learning process. All material contained in the curriculum is repeated several times over the course of the sessions so students make any corrections on their own at their own pace.

As homework students are asked to repeat as many new linguistic items as they can to speakers and non speakers of the target language in their daily lives. They are asked to share and teach new words and phrases and new songs to family members or friends and to practice the physical adaptation exercises a few minutes daily.

8—Students sing along with a prerecorded ‘Goodbye’ song in the target language. At the first session with a group the teacher breaks down each word of the song by clapping out the syllables as s/he pronounces it. The students then follow the rhythm of the prerecorded music by clapping the down beat as they sing the lyrics of the song standing in a circle.

The steps for the physical relaxation and language adaptation embodiment are as follows:
1. Students shake and name parts of the body first in the native language then in the target language.
2. Students do verbal imitations of certain animal sounds for tongue positions and movements of the new pronunciation.
3. Deep breathing exercises are combined with the vowel positions and sounds of the target language.
The steps for the playing of percussion instruments, speaking, singing songs, chanting and movement embodiment are as follows:
1. Students chant as a group an introduction phrase in the target language and clap the rhythm of the phrase. After each time the phrase is chanted one student says his/her name.
2. Teacher introduces first percussion instrument and does a ‘call and answer’ drum conversation. The teacher beats a group of notes at a slow to moderate tempo. Students listen then answer by repeating both the drummed notes and ‘sticking’ (movement of the hands). Exercise is repeated with eyes closed to develop listening skills. This is ear training for both music and language.
3. Teacher adds numbers to the call and answer drum exercise. Teacher says one (1) to three (3) numbers in sequence in the target language and drums the rhythm of the words at a slow to moderate tempo. Students repeat the words and beats on the instrument.
The teacher drums specific dynamics and calls out the word for the dynamic in the target language. Students drum each dynamic and repeat the word for the dynamic in the new language.
Teacher drums varied tempos and calls out the word for the tempo in the target language. Students drum each tempo and repeat the word for the tempo in the new language.
4. The ‘Greeting’ song. Students sing the first prerecorded song in the target language and drum the down beat of the music on the drum.
5. Teacher presents the theme by engaging the students in a simple conversation introducing small batches or chunks of language with key words and phrases. The teacher repeats the items in the native language then in the target language and breaks down each single word or words of a complete phrase by saying and drumming or clapping it out. Students repeat the linguistic items and drummed or clapped beats.
6. Teacher introduces a new percussion instrument and repeats key words and phrases with beats on the instrument or with hand claps and a specific body movement that follows the rhythm. Students repeat the words and beats on the new instrument with the body movement. The teacher adds the melodic quality to the complete phrase. Students repeat the items adding the melodic quality. The exercise is then done with a prerecorded song or chant.
7. The teacher elicits the new linguistic items from the student to make them consciously aware of what they have learned, to achieve long term memory and to assess the progress of the students.
As homework students are asked to repeat as many of the new linguistic items to speakers and non speakers of the language. They are encouraged to sing a song reviewed in the session for family members and friends.
8. Students sing and clap the rhythm of the prerecorded ‘Goodbye’ song in the target language.

What is claimed is:

1. A method of teaching students a language utilizing percussion instruments, a repertoire of prerecorded songs and chants composed exclusively for and included in set curriculums, specific rhythmic body movements, non verbal communication that follow the rhythm, and breathing and vocal sound exercises so that students hear the pulse and sound of the new language through rhythm and unconsciously create a brain and muscle memory of the new words and phases, the method comprising the steps of:
students isolating, shaking and relaxing parts of the body and saying the name of the parts in the native language then in the target language; students verbally imitating specific animal sounds placing an open palm an inch away from the mouth to feel positions and movements of the tongue and to hear the sounds used in the pronunciation; teacher playing a game of calling out a simple command involving a part of the body in the target language and students responding by identifying the part of the body and performing the command; having students do deep breathing exercises combined with the vowel positions and sounds of the target language;

2. A method of teaching students a language utilizing percussion instruments, an original repertoire of songs and chants arranged thematically and included in set curriculums, specific rhythmic body movements, paralinguistic that follow the rhythm, and breathing and vocal sound exercises so that students hear the pulse and sound of the new language through rhythm and unconsciously create a brain and muscle memory of the new words and phrases, the method comprising the steps of:
students chanting an ‘introduction’ phrase as a group in the target language with a hand clap and having one student say his/her name after each time the phrase is chanted; students singing the first prerecorded ‘Greeting’ song in the target language and drumming the main beat of the music on a percussion instrument; teacher introducing a ‘call and answer’ drum exercise by drumming a series of rhythmic patterns each with varied dynamics and tempos on the instrument and having students listen then repeat each pattern by drumming it on their instrument with eyes open then closed; students make a series of percussive sounds verbally in the vowel positions of the new language with the matching beat on the instrument; teacher presenting the theme of the lesson by introducing key words and complete phrases in the target language and engaging students in a simple conversation using these words and phrase; teacher saying and beating the rhythm of the new linguistic items on the instrument and having students repeat the items by saying and beating the rhythm on their instrument; students drumming, performing a specific body movement and singing along with a prerecorded song or chant containing the new linguistic items; teacher eliciting the linguistic items from the student after the exercise to make students consciously aware of what they have learned and to assess students' progress; students singing a prerecorded ‘Goodbye’ song in the target language beating the main beat of the music with a hand clap.

3. The method as claimed in claim 2 wherein the songs contained in the original repertoire have memorable melodic and rhythmic qualities designed to teach the structure and sound of the new linguistic items, are lively in spirit and are no more than two and a half (2½) minutes in length.

4. The method as claimed in 2 wherein the chants contained in the original repertoire have memorable rhythmic qualities designed to break up words into syllables with their emphasis, contain no more than three (3) words and are no more than three (3) minutes in length.

5. The method as claimed in 2 wherein a prerecorded ‘Greeting’ song in the new language is sung at the beginning of each and every class.

6. The method as claimed in 2 wherein a prerecorded ‘Goodbye’ song in the new language is sung at the end of each and every class.

7. The method as claimed in 2 wherein the percussion instruments are small hand held or are placed on a surface and are hit with either one (1) or two (2) open hands, mallets or drum sticks.

8. The method as claimed in claim 2 further comprising the step of: teacher calling out numbers in the new language and playing the beats of the words in the ‘call and answer’ drum exercise and students repeating the words and beats on their instrument.

9. The method as claimed in claim 2 further comprising the step of: teacher calling out various musical dynamics in the new language and drumming each dynamic in the ‘call and answer’ drum exercise and students repeating each word and beat each dynamic on their instrument.

10. The method as claimed in 2 further comprising the step of: providing a game where teacher calls out a simple command involving a part of the body in the target language and students respond by identifying the part of the body and performing the command.

11. The method as claimed in claim 2 further comprising the steps of: teacher saying a word or complete phrase in the target language and performing the corresponding action, students repeating the word or complete phrase and action, teacher then asking the students to define the new language items according to the action.

12. The method as claimed in claim 2 further comprising the steps of: using gestures, vocal pitch, volume, intonation and emotions of which that all follow the rhythm of the drumming, singing, chanting and body movements.
